(19) United States
(12) Patent Application Publication
(10) Pub. No.: US 2023/0229029 A1
(43) Pub. Date: Jul. 20, 2023

(54) OPTICAL PHASE SHIFTER HAVING L-SHAPED PN JUNCTION AND MANUFACTURING METHOD THEREFOR

(71) Applicant: INDUSTRY-UNIVERSITY COOPERATION FOUNDATION HANYANG UNIVERSITY ERICA CAMPUS, Ansan-Si (KR)

(72) Inventors: Young Hyun KIM, Ansan-si (KR); Young Joo BAE, Seoul (KR)

(73) Assignee: INDUSTRY-UNIVERSITY COOPERATION FOUNDATION HANYANG UNIVERSITY ERICA CAMPUS, Ansan-Si, Gyeonggi-do (KR)

(21) Appl. No.: 18/154,065

(22) Filed: Jan. 13, 2023

(30) Foreign Application Priority Data
Jan. 20, 2022 (KR) 10-2022-0008676

(51) Int. Cl. G02F 1/025; G02F 1/21; G02F 1/015; G02B 6/136; G02F 1/225

(52) U.S. Cl. CPC G02F 1/025; G02B 6/136; G02F 1/0151; G02F 1/212; G02F 1/2257; G02B 2006/12097

(57) ABSTRACT

Provided is an optical phase shifter. The optical phase shifter includes: a slab waveguide in which a first slab region doped into a first conductivity type and a second slab region doped into a second conductivity type are arranged side by side to form a PN junction; and a rib waveguide disposed on the slab waveguide such that one side of the rib waveguide makes contact with the first slab region, and an opposite side of the rib waveguide makes contact with the second slab region, wherein the rib waveguide includes first to third rib waveguide layers that are sequentially stacked, the first and third rib waveguide layers include silicon (Si), and the second rib waveguide layer includes silicon-germanium (SiGe).

### CROSS-REFERENCE TO RELATED APPLICATION

This application claims the benefit of Republic of Korea Patent Application 10-2022-0008676 (filed 20 Jan. 2022), the entire disclosure of which is hereby incorporated by reference herein.

### BACKGROUND OF THE INVENTION

### 1. Field of the Invention

The present invention relates to an optical phase shifter and a manufacturing method therefor, and more particularly, to an optical phase shifter having an L-shaped PN junction and a manufacturing method therefor.

This research was supported by the Technology Innovation Program (20015909) through the Korea Evaluation Institute of Industrial Technology (KEIT), funded by the Ministry of Trade, Industry & Energy (MOTIE, Korea).

This work was supported by the National Research Foundation of Korea(NRF) grant funded by the Korea government(MSIT) (No. 2022K1A3A1A79090726).

This research was supported by Korea Basic Science Institute (National research Facilities and Equipment Center) grant funded by the Ministry of Education (2021R1A6C101A405).

### 2. Description of the Related Art

FIG. 1 is a plan view showing a Mach-Zehnder optical modulator according to the related art, and FIG. 2 is a plan view showing a ring modulator according to the related art. An optical phase shifter will be described with reference to FIGS. 1 and 2.

A Mach-Zehnder optical modulator may use a Mach-Zehnder interferometer. The Mach-Zehnder interferometer refers to a device used to split a light from a single source into two waveguides and determine a phase difference between beams derived through the waveguides different from each other. The Mach-Zehnder optical modulator may include optical phase shifters 10 in two arms into which the light is divided.

Meanwhile, a ring modulator refers to an optical modulator using a resonance phenomenon of a ring, and the ring modulator may generally include an optical waveguide that forms a loop. In detail, the ring modulator may be configured such that resonance occurs when a length of an optical path exactly matches a specific wavelength, and only a light having the specific wavelength passes through an optical phase shifter 10 having a ring shape through the resonance as a light passes through the waveguide.

As described above, the optical phase shifter refers to a device used in an optical modulator, and the optical phase shifter may have a function of controlling a phase of a light through a change of a refractive index of a material. According to the related art, silicon (Si) has been used as a main material of the optical phase shifter. However, due to limitations in physical properties of silicon, an efficiency of the optical phase shifter may be low. Accordingly, researches on various methods for improving the efficiency of the optical phase shifter have been conducted.

### SUMMARY OF THE INVENTION

One technical object of the present invention is to provide an optical phase shifter having an L-shaped PN junction and a manufacturing method therefor.

Another technical object of the present invention is to provide an optical phase shifter and a manufacturing method therefor, capable of improving an optical modulation efficiency.

Still another technical object of the present invention is to provide a method for manufacturing an optical phase shifter with a simplified process.

Yet another technical object of the present invention is to provide an optical phase shifter and a manufacturing method therefor, capable of improving performance of an optical modulator.

Technical objects of the present invention are not limited to the above-described technical objects.

To achieve the technical objects described above, according to the present invention, there is provided an optical phase shifter.

According to one embodiment, the optical phase shifter includes: a slab waveguide in which a first slab region doped into a first conductivity type and a second slab region doped into a second conductivity type are arranged side by side to form a PN junction; and a rib waveguide disposed on the slab waveguide such that one side of the rib waveguide makes contact with the first slab region, and an opposite side of the rib waveguide makes contact with the second slab region, wherein the rib waveguide includes first to third rib waveguide layers that are sequentially stacked, the first and third rib waveguide layers include silicon (Si), and the second rib waveguide layer includes silicon-germanium (SiGe).

According to one embodiment, when a reverse voltage is applied to the optical phase shifter, concentrations of electrons and holes in the second rib waveguide layer may be changed to change a refractive index of the second rib waveguide layer, and a phase of a light passing through the second rib waveguide layer may be controlled by the change of the refractive index.

According to one embodiment, a thickness of the first rib waveguide layer that is adjacent to the slab waveguide may be thinner than a thickness of the third rib waveguide layer.

According to one embodiment, a depletion layer may be formed between the first slab region and the second slab region and between the second slab region and the first rib waveguide layer, and, when a reverse voltage is applied to the optical phase shifter, an area of the depletion layer may be increased.

According to one embodiment, the first to third rib waveguide layers may be doped into the first conductivity type.

According to one embodiment, the first slab region may include a first-first slab region having a first doping concentration, a first-second slab region having a second doping concentration that is lower than the first doping concentration, and a first-third slab region having a third doping concentration that is lower than the second doping concentration, the first-first to first-third slab regions may be arranged side by side with each other, the second slab region may include a second-first slab region having a first doping concentration, a second-second slab region having a second doping concentration that is lower than the first doping concentration, and a second-third slab region having a third doping concentration that is lower than the second doping concentration, and the second-first to second-third slab regions may be arranged side by side with each other.

According to one embodiment, the slab waveguide is disposed such that the first-third slab region and the second-third slab region make contact with each other.

According to one embodiment, a thickness of the first-first slab region may be thicker than a thickness of each of the first-second slab region and the first-third slab region, and a thickness of the second-first slab region may be thicker than a thickness of each of the second-second slab region and the second-third slab region.

According to one embodiment, when an area in which the second slab region and the first rib waveguide layer overlap is relatively widened, an optical modulation efficiency may be improved while an optical modulation speed may be reduced, and, when an area in which the second slab region and the first rib waveguide layer overlap is relatively narrowed, the optical modulation efficiency may be reduced while the optical modulation speed may be improved.

According to one embodiment, the rib waveguide may further include: a fourth rib waveguide layer including silicon-germanium (SiGe) and disposed on the third rib waveguide layer; and a fifth rib waveguide layer including silicon (Si) and disposed on the fourth rib waveguide layer.

To achieve the technical objects described above, according to the present invention, there is provided a method for manufacturing an optical phase shifter.

According to one embodiment, the method for manufacturing the optical phase shifter includes: preparing a substrate structure in which a base substrate, an insulating layer, and a silicon (Si) layer are sequentially stacked; forming a first empty space in a central portion of the silicon layer by etching the central portion of the silicon layer such that a level of the central portion of the silicon layer is lower than a level of each of both ends of the silicon layer; forming a slab waveguide in which a PN junction is formed by a first region and a second region by doping a first region of the etched silicon layer into a first conductivity type and doping a second region of the etched silicon layer, which is arranged side by side with the first region of the etched silicon layer, into a second conductivity type; depositing a mask in the first empty space formed in a central portion of the slab waveguide; forming a second empty space between the slab waveguide and the mask by etching the mask to expose a portion of the first region and a portion of the second region; forming a rib waveguide in which first to third rib waveguide layers are sequentially stacked in the second empty space; and forming electrodes on the first region and the second region of the slab waveguide, respectively, wherein the first and third rib waveguide layers include silicon (Si), and the second rib waveguide layer includes silicon-germanium (SiGe).

According to one embodiment, the forming of the rib waveguide in the second empty space may include: forming a first rib waveguide layer in the second empty space by growing silicon (Si) from the slab waveguide; forming a second rib waveguide layer on the first rib waveguide layer by growing silicon-germanium (Si-Ge) from the first rib waveguide layer; and forming a third rib waveguide layer on the second rib waveguide layer by growing silicon (Si) from the second rib waveguide layer.

According to another embodiment, the method for manufacturing the optical phase shifter includes: preparing a substrate structure in which a base substrate, an insulating layer, and a silicon (Si) layer are sequentially stacked; forming an empty space in a central portion of the silicon layer by etching the central portion of the silicon layer such that a level of the central portion of the silicon layer is lower than a level of each of both ends of the silicon layer; forming a slab waveguide in which a PN junction is formed by a first region and a second region by doping a first region of the etched silicon layer into a first conductivity type and doping a second region of the etched silicon layer, which is arranged side by side with the first region of the etched silicon layer, into a second conductivity type; filling the empty space formed in a central portion of the slab waveguide with a rib waveguide in which first to third rib waveguide layers are stacked by sequentially forming the first to third rib waveguide layers along a surface profile of the slab waveguide; performing planarization such that a top surface of each of both ends of the slab waveguide and a top surface of the rib waveguide filling the empty space have a same level by removing the rib waveguide formed on the both ends of the slab waveguide while allowing the rib waveguide filling the empty space to remain; etching the rib waveguide filling the empty space to expose a portion of the first region of the slab waveguide and a portion of the second region of the slab waveguide; and forming electrodes on the first region and the second region of the slab waveguide, respectively.

According to another embodiment, the first and third rib waveguide layers may include silicon (Si), and the second rib waveguide layer may include silicon-germanium (SiGe).

According to an embodiment of the present invention, the optical phase shifter may include: a slab waveguide in which a first slab region doped into a first conductivity type and a second slab region doped into a second conductivity type are arranged side by side to form a PN junction; and a rib waveguide disposed on the slab waveguide such that one side of the rib waveguide makes contact with the first slab region, and an opposite side of the rib waveguide makes contact with the second slab region, wherein the rib waveguide includes first to third rib waveguide layers that are sequentially stacked, the first and third rib waveguide layers include silicon (Si), and the second rib waveguide layer includes silicon-germanium (SiGe). In addition, a thickness of the first rib waveguide layer that is adjacent to the slab waveguide may be thinner than a thickness of the third rib waveguide layer.

Accordingly, changes in concentrations of electrons and holes in the rib waveguide can intensively occur in the second rib waveguide layer. Accordingly, an effective refractive index change amount can be increased, so that an optical modulation efficiency of an optical modulator including the optical phase shifter can be improved.

### BRIEF DESCRIPTION OF THE DRAWINGS

FIG. 1 is a plan view showing a Mach-Zehnder optical modulator according to the related art.

FIG. 2 is a plan view showing a ring modulator according to the related art.

FIG. 3 is a view for describing an optical phase shifter according to a first embodiment of the present invention.

FIG. 4 is a view for describing a slab waveguide included in the optical phase shifter according to the first embodiment of the present invention.

FIG. 5 is a view for describing a rib waveguide included in the optical phase shifter according to the first embodiment of the present invention.

FIG. 6 is a view for describing a depletion layer in the optical phase shifter according to the first embodiment of the present invention.

FIG. 7 is a view for describing an optical phase shifter according to a second embodiment of the present invention.

FIG. 8 is a view for describing a rib waveguide included in the optical phase shifter according to the second embodiment of the present invention.

FIG. 9 is a view for describing a step S110 of a method for manufacturing the optical phase shifter according to the first embodiment of the present invention.

FIG. 10 is a view for describing a step S120 of the method for manufacturing the optical phase shifter according to the first embodiment of the present invention.

FIG. 11 is a view for describing a step S130 of the method for manufacturing the optical phase shifter according to the first embodiment of the present invention.

FIG. 12 is a view for describing a step S140 of the method for manufacturing the optical phase shifter according to the first embodiment of the present invention.

FIG. 13 is a view for describing a step S150 of the method for manufacturing the optical phase shifter according to the first embodiment of the present invention.

FIG. 14 is a view for describing a step S160 of the method for manufacturing the optical phase shifter according to the first embodiment of the present invention.

FIG. 15 is a view for describing a step S170 of the method for manufacturing the optical phase shifter according to the first embodiment of the present invention.

FIG. 16 is a view for describing steps S210, S220, and S230 of a method for manufacturing the optical phase shifter according to the second embodiment of the present invention.

FIG. 17 is a view for describing a step S241 of the method for manufacturing the optical phase shifter according to the second embodiment of the present invention.

FIG. 18 is a view for describing a step S242 of the method for manufacturing the optical phase shifter according to the second embodiment of the present invention.

FIG. 19 is a view for describing a step S243 of the method for manufacturing the optical phase shifter according to the second embodiment of the present invention.

FIG. 20 is a view for describing a step S250 of the method for manufacturing the optical phase shifter according to the second embodiment of the present invention.

FIG. 21 is a view for describing a step S260 of the method for manufacturing the optical phase shifter according to the second embodiment of the present invention.

FIG. 22 is a view for describing a step S270 of the method for manufacturing the optical phase shifter according to the second embodiment of the present invention.

FIG. 23 is a graph for comparing effective refractive index change amounts of optical phase shifters according to Experimental Example and Comparative Examples of the present invention.

FIG. 24 is a graph for comparing modulation efficiencies of the optical phase shifters according to Experimental Example and Comparative Examples of the present invention.

### DETAILED DESCRIPTION OF THE INVENTION

Hereinafter, exemplary embodiments of the present invention will be described in detail with reference to the accompanying drawings. However, the technical idea of the present invention is not limited to the embodiments described herein, but may be realized in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of films and regions are exaggerated for effective description of the technical contents.

In addition, in various embodiments of the present disclosure, the terms such as first, second, and third are used to describe various elements, but the elements are not limited by the terms. The terms are used only to distinguish one element from another element. Therefore, an element mentioned as a first element in one embodiment may be mentioned as a second element in another embodiment. The embodiments described and illustrated herein include their complementary embodiments. Further, the term “and/or” used herein is used to include at least one of the elements enumerated before and after the term.

As used herein, expressions in a singular form include a meaning of a plural form unless the context clearly indicates otherwise. Further, the terms such as “including” and “having” are intended to designate the presence of features, numbers, steps, elements, or combinations thereof described in the present disclosure, and shall not be construed to preclude any possibility of the presence or addition of one or more other features, numbers, steps, elements, or combinations thereof. In addition, the term “connection” used herein is used to include both indirect and direct connections of a plurality of elements.

Further, in the following description of the present invention, detailed descriptions of known functions or configurations incorporated herein will be omitted when they may make the gist of the present invention unnecessarily unclear.

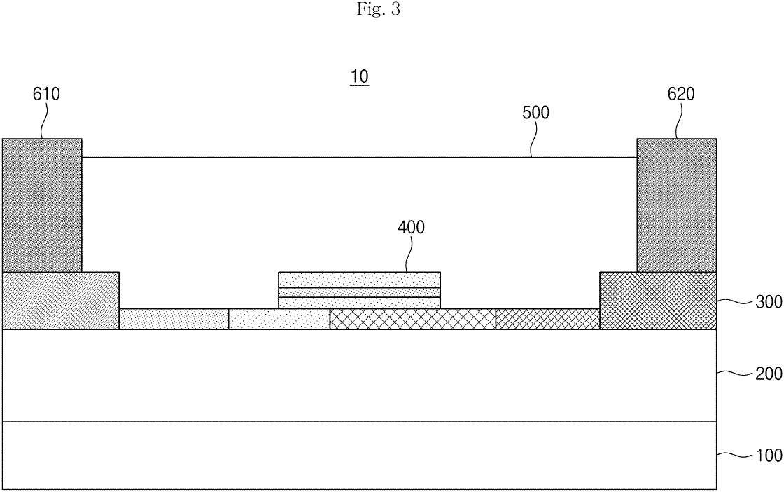

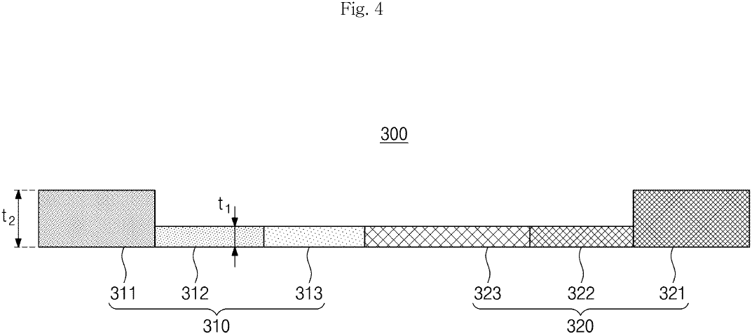

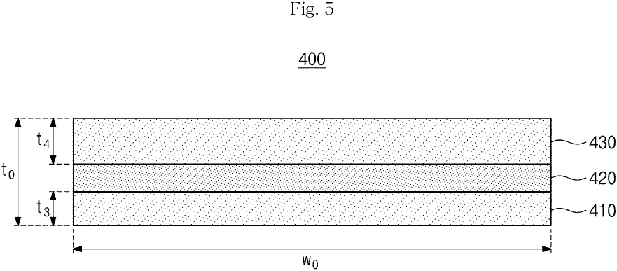

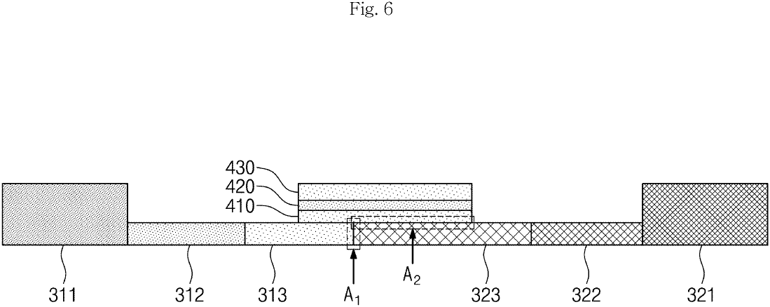

FIG. 3 is a view for describing an optical phase shifter according to a first embodiment of the present invention, FIG. 4 is a view for describing a slab waveguide included in the optical phase shifter according to the first embodiment of the present invention, FIG. 5 is a view for describing a rib waveguide included in the optical phase shifter according to the first embodiment of the present invention, and FIG. 6 is a view for describing a depletion layer in the optical phase shifter according to the first embodiment of the present invention.

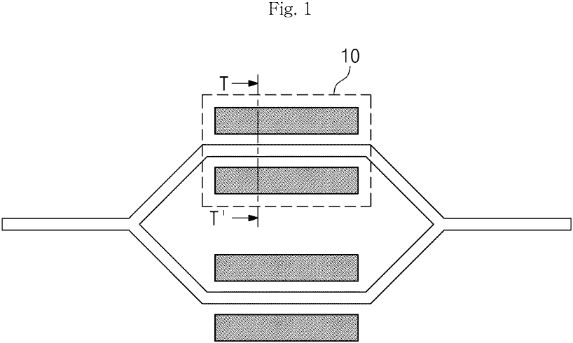

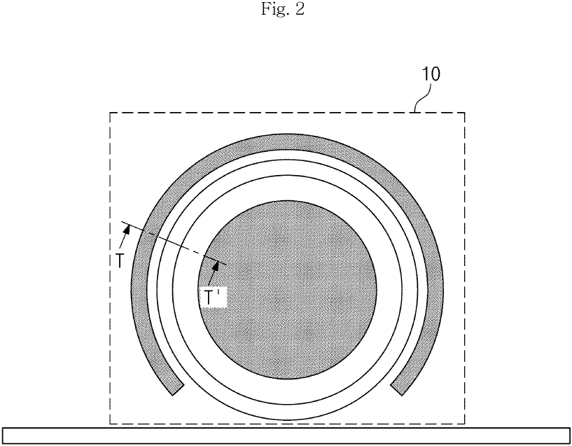

FIG. 3 shows a region corresponding to a section taken along a line T-T′ of FIGS. 1 and 2. Referring to FIG. 3, according to a first embodiment of the present invention, an optical phase shifter 10 may include a base substrate 100, an insulating layer 200, a slab waveguide 300, a rib waveguide 400, a protective layer 500, a first electrode 610, and a second electrode 620. Hereinafter, each component will be described.

The slab waveguide 300 may be disposed on the base substrate 100. According to one embodiment, the base substrate 100 may be a silicon (Si) waveguide. The insulating layer 200 may be disposed between the slab waveguide 300 and the base substrate 100. According to one embodiment, the insulating layer 200 may include silicon oxide (SiO₂).

The slab waveguide 300 may have an L-shaped PN junction structure. Hereinafter, the slab waveguide 300 will be described in more detail with reference to FIG. 4.

The slab waveguide 300 may include silicon (Si), and may include a first slab region 310 doped into a first conductivity type and a second slab region 320 doped into a second conductivity type. The first region 310 and the second region 320 may be arranged side by side to form a PN junction. For example, the first conductivity type may include a p-type. Meanwhile, the second conductivity type may include n-type. In other words, the first region 310 may include silicon doped with a p-type dopant (p-Si), while the second region 320 may include silicon doped with an n-type dopant (n-Si). The first region 310 may be doped with boron (B) to achieve p-type doping, and the second region 320 may be doped with phosphorus (P) to achieve n-type doping.

The first slab region 310 may include a first-first slab region 311, a first-second slab region 312, and a first-third slab region 313. The first-first slab region 311 to the first-third slab region 313 may be arranged side by side. In addition, the first-first slab region 311 to the first-third slab region 313 may have mutually different doping concentrations.

For example, the first-first slab region 311 may have a first doping concentration. Meanwhile, the first-second slab region 312 may have a second doping concentration that is lower than the first doping concentration. Meanwhile, the first-third slab region 313 may have a third doping concentration that is lower than the second doping concentration. In detail, the first doping concentration may be 10²⁰ cm⁻³. Meanwhile, the second doping concentration may be 10¹⁹ cm⁻³. Meanwhile, the third doping concentration may be 10¹⁸ cm⁻³. In other words, the first slab region 310 may be configured such that the first-first slab region 311 including p⁺⁺-Si, the first-second slab region 312 including p⁺-Si, and the first-third slab region 313 including p-Si are arranged side by side.

According to one embodiment, a thickness t₂ of the first-first slab region 311 may be thicker than a thickness t₁ of each of the first-second slab region 312 and the first-third slab region 313. For example, the thickness t₂ of the first-first slab region 311 may be 215 nm. Meanwhile, the thickness t₁ of each of the first-second slab region 312 and the first-third slab region 313 may be 60 nm. Accordingly, the first region 310 may have an L-shape due to the first-first slab region 311 to the first-third slab region 313.

The second slab region 320 may include a second-first slab region 321, a second-second slab region 322, and a second-third slab region 323. The second-first slab region 321 to the second-third slab region 323 may be arranged side by side. In addition, the second-first slab region 321 to the second-third slab region 323 may have mutually different doping concentrations.

For example, the second-first slab region 321 may have a first doping concentration. Meanwhile, the second-second slab region 322 may have a second doping concentration that is lower than the first doping concentration. Meanwhile, the second-third slab region 323 may have a third doping concentration that is lower than the second doping concentration. In detail, the first doping concentration may be 10²⁰ cm⁻³. Meanwhile, the second doping concentration may be 10¹⁹ cm⁻³. Meanwhile, the third doping concentration may be 10¹⁸ cm⁻³. In other words, the second slab region 320 may be configured such that the second-first slab region 321 including n⁺⁺-Si, the second-second slab region 322 including n⁺-Si, and the second-third slab region 323 including n-Si are arranged side by side.

According to one embodiment, a thickness t₂ of the second-first slab region 321 may be thicker than a thickness t₁ of each of the second-second slab region 322 and the second-third slab region 323. For example, the thickness t₂ of the second-first slab region 321 may be 215 nm. Meanwhile, the thickness t₁ of each of the second-second slab region 322 and the second-third slab region 323 may be 60 nm. Accordingly, the second region 320 may have an L-shape due to the second-first slab region 321 to the second-third slab region 323.

When the first slab region 310 and the second slab region 320 include the first-first to first-third slab regions 311, 312, and 313 and the second-first to second-third slab regions 321, 322, and 323, respectively, the first-third slab region 313 and the second-third slab region 323 may make contact with each other. A depletion layer may be formed in a first PN junction region A₁ defined between the first-third slab region 313 and the second-third slab region 323.

Referring to FIGS. 5 and 6, the rib waveguide 400 may be disposed on the slab waveguide 300. According to one embodiment, the rib waveguide 400 may be disposed such that one side of the rib waveguide 400 makes contact with the first-third slab region 313, and an opposite side of the rib waveguide 400 makes contact with the second-third slab region 323. For example, a thickness t₀ of the rib waveguide 400 may be 160 nm, and a width w₀ of the rib waveguide 400 may be 500 nm.

The rib waveguide 400 may include a first rib waveguide layer 410, a second rib waveguide layer 420, and a third rib waveguide layer 430. The first rib waveguide layer 410 may make contact with the slab waveguide 300, and the second rib waveguide layer 420 and the third rib waveguide layer 430 may be sequentially stacked on the first rib waveguide layer 410.

According to one embodiment, while the first rib waveguide layer 410 and the third rib waveguide layer 430 include silicon (Si), the second rib waveguide layer 420 may include silicon-germanium (Si—Ge). In addition, all of the first to third rib waveguide layers 410, 420, and 430 may be doped into the first conductivity type (p-type). In other words, the rib waveguide 400 may have a structure in which the first rib waveguide layer 410 including p-Si, the second rib waveguide layer 420 including p-SiGe, and the third rib waveguide layer 430 including p-Si are sequentially stacked. A ratio of germanium (Ge) in the rib waveguide 400 may be 0 to 50 mol%.

In addition, since the first rib waveguide layer 410 is doped into the first conductivity type (p-type), a depletion layer may be formed in a second PN junction region A₂ defined between the first rib waveguide layer 410 and the second-third slab region 323.

According to one embodiment, a thickness t₃ of the first rib waveguide layer 410 may be thinner than a thickness t₄ of the third rib waveguide layer 430. Accordingly, an optical modulation efficiency of the optical phase shifter 10 may be improved.

In detail, when a reverse voltage is applied to the optical phase shifter 10, concentrations of electrons and holes in the rib waveguide 400 may be changed, and areas of the depletion layers formed in the first and second PN junction regions A₁ and A₂ may be increased. Accordingly, a refractive index of the rib waveguide 400 may be changed, and a phase of a light passing through the rib waveguide 400 may be controlled by the change of the refractive index.

However, since silicon-germanium (SiGe) has a smaller hole effective mass than silicon (Si), an effective refractive index change amount may be increased. In other words, the effective refractive index change amount may be further increased in a case where concentrations of electrons and holes in the second rib waveguide layer 420 are changed as compared with a case where concentrations of electrons and holes in the first and third rib waveguide layers 410 and 430 are changed.

As described above, when the thickness t₃ of the first rib waveguide layer 410 is thinner than the thickness t₄ of the third rib waveguide layer 430, changes in concentration of electrons and holes in the rib waveguide 400 may intensively occur in the second rib waveguide layer 420. Accordingly, the effective refractive index change amount may be increased, so that an optical modulation efficiency of an optical modulator including the optical phase shifter 10 may be improved.

According to one embodiment, as an area of the second PN junction region A₂ is controlled, an optical modulation efficiency and an optical modulation speed of the optical modulator including the optical phase shifter 10 may be controlled. In detail, when the area of the second PN junction region A₂ is relatively widened, the optical modulation efficiency may be improved while the optical modulation speed may be reduced. On the contrary, when the area of the second PN junction region A₂ is relatively narrowed, the optical modulation efficiency may be reduced while the optical modulation speed may be increased.

The protective layer 500, the first electrode 610, and the second electrode 620 may be further disposed on the slab waveguide 300. The first electrode 610 may be disposed on the first-first slab region 311. Meanwhile, the second electrode 620 may be disposed on the second-first slab region 321. The protective layer 500 may be disposed on the slab waveguide 300 such that one side of the protective layer 500 makes contact with the first electrode 610, and an opposite side of the protective layer 500 makes contact with the second electrode 620, and the protective layer 500 may cover the rib waveguide 400. For example, the protective layer 500 may include silicon oxide (SiO₂).

As a result, according to the first embodiment of the present invention, the optical phase shifter 10 may include: a slab waveguide 300 in which a first slab region 310 doped into a first conductivity type and a second slab region 320 doped into a second conductivity type are arranged side by side to form a PN junction; and a rib waveguide 400 disposed on the slab waveguide 300 such that one side of the rib waveguide 400 makes contact with the first slab region 310, and an opposite side of the rib waveguide 400 makes contact with the second slab region 320, wherein the rib waveguide 400 includes first to third rib waveguide layers 410, 420, and 430 that are sequentially stacked, the first and third rib waveguide layers 410 and 430 include silicon (Si), and the second rib waveguide layer 420 includes silicon-germanium (SiGe). In addition, a thickness of the first rib waveguide layer 410 that is adjacent to the slab waveguide 300 may be thinner than a thickness of the third rib waveguide layer 430.

Accordingly, changes in concentrations of electrons and holes in the rib waveguide 400 may intensively occur in the second rib waveguide layer 420. Accordingly, the effective refractive index change amount may be increased, so that the optical modulation efficiency of the optical modulator including the optical phase shifter 10 may be improved.

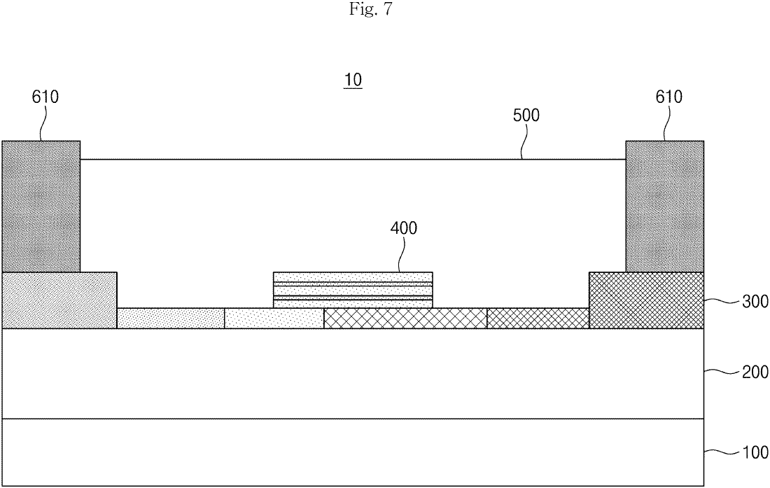

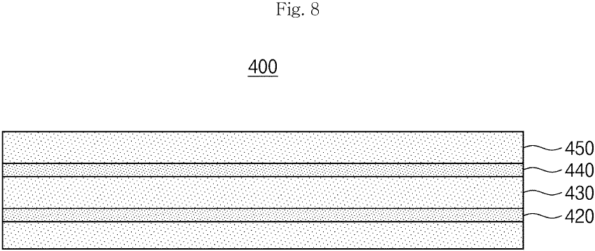

FIG. 7 is a view for describing an optical phase shifter according to a second embodiment of the present invention, and FIG. 8 is a view for describing a rib waveguide included in the optical phase shifter according to the second embodiment of the present invention.

Referring to FIG. 7, according to a second embodiment of the present invention, an optical phase shifter 10 may include a base substrate 100, an insulating layer 200, a slab waveguide 300, a rib waveguide 400, a protective layer 500, a first electrode 610, and a second electrode 620. The base substrate 100, the insulating layer 200, the slab waveguide 300, the protective layer 500, the first electrode 610, and the second electrode 620 may be the same as the base substrate 100, the insulating layer 200, the slab waveguide 300, the protective layer 500, the first electrode 610, and the second electrode 620 of the optical phase shifter 10 according to the first embodiment described with reference to FIGS. 3 to 6. Accordingly, detailed descriptions thereof will be omitted.

The rib waveguide 400 may have a structure in which a first rib waveguide layer 410, a second rib waveguide layer 420, a third rib waveguide layer 430, a fourth rib waveguide layer 440, and a fifth rib waveguide layer 450 are sequentially stacked. According to one embodiment, the first rib waveguide layer 410, the third rib waveguide layer 430, and the fifth rib waveguide layer 450 may include silicon (Si). Meanwhile, the second rib waveguide layer 420 and the fourth rib waveguide layer 440 may include silicon-germanium (SiGe). In addition, all of the first to fifth rib waveguide layers 410, 420, 430, 440, and 450 may be doped into the first conductivity type (p-type).

In other words, the rib waveguide 400 included in the optical phase shifter 10 according to the second embodiment may further include the fourth rib waveguide layer 440 and the fifth rib waveguide layer 450 as compared with the rib waveguide 400 included in the optical phase shifter 10 according to the first embodiment. Accordingly, the rib waveguide 400 according to the second embodiment may have a higher content of germanium (Ge) than the rib waveguide 400 according to the first embodiment. In other words, since the rib waveguide 400 according to the second embodiment may be epitaxially grown in a form of a thin film having a thin thickness while increasing a ratio of germanium (Ge), an overall content of germanium (Ge) may be increased.

The optical phase shifters according to the embodiments of the present invention have been described above. Hereinafter, methods for manufacturing optical phase shifters according to embodiments of the present invention will be described.

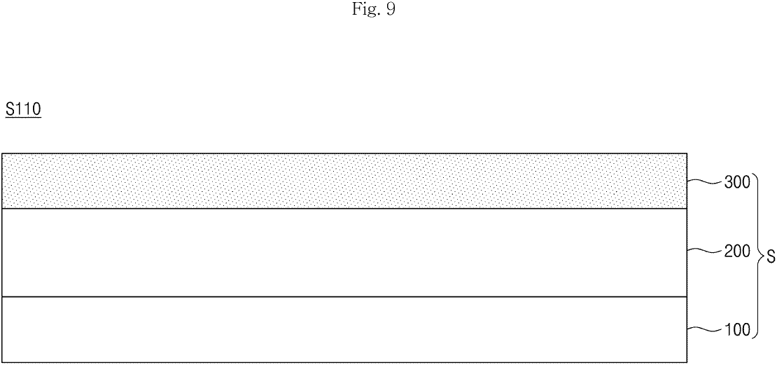

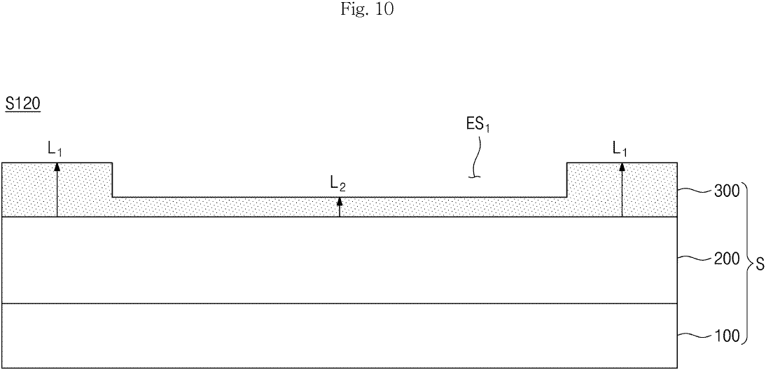

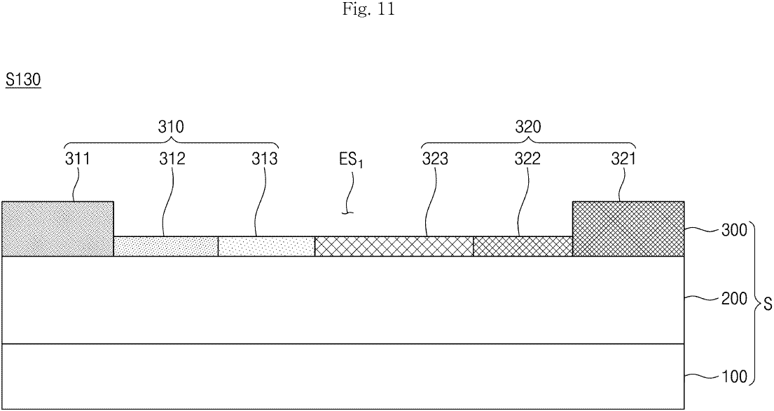

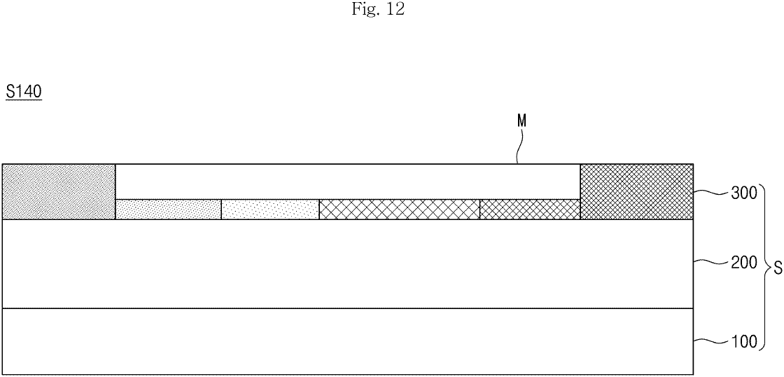

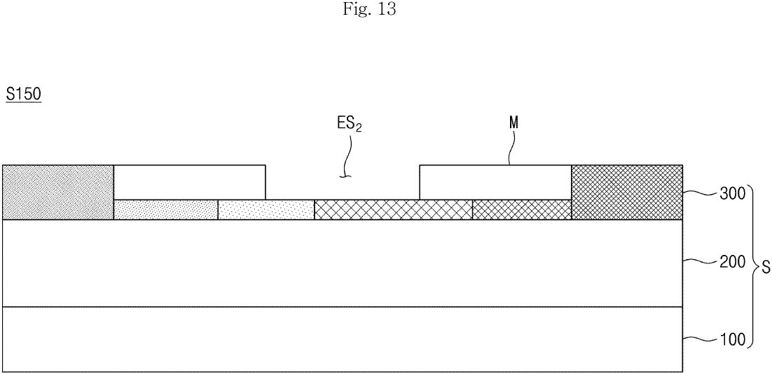

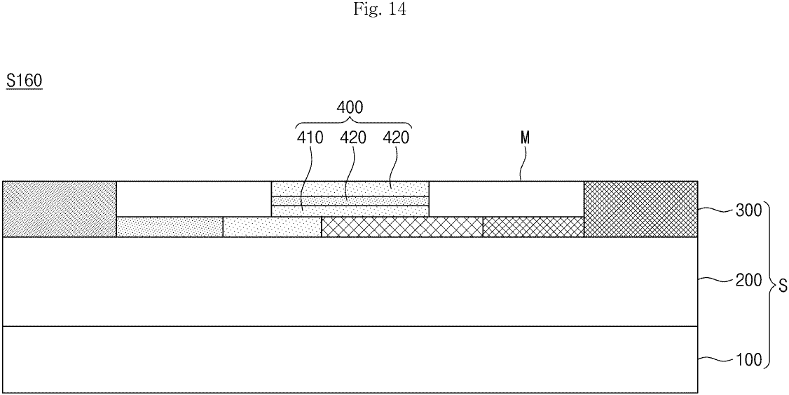

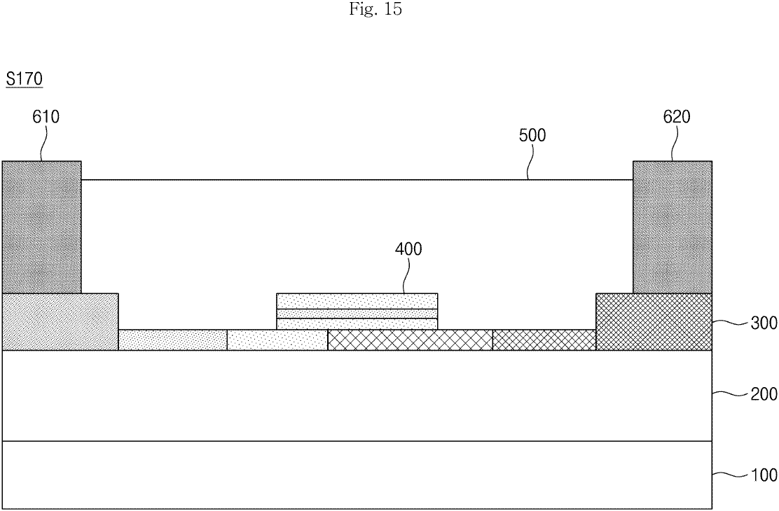

FIG. 9 is a view for describing a step S110 of a method for manufacturing the optical phase shifter according to the first embodiment of the present invention, FIG. 10 is a view for describing a step S120 of the method for manufacturing the optical phase shifter according to the first embodiment of the present invention, FIG. 11 is a view for describing a step S130 of the method for manufacturing the optical phase shifter according to the first embodiment of the present invention, FIG. 12 is a view for describing a step S140 of the method for manufacturing the optical phase shifter according to the first embodiment of the present invention, FIG. 13 is a view for describing a step S150 of the method for manufacturing the optical phase shifter according to the first embodiment of the present invention, FIG. 14 is a view for describing a step S160 of the method for manufacturing the optical phase shifter according to the first embodiment of the present invention, and FIG. 15 is a view for describing a step S170 of the method for manufacturing the optical phase shifter according to the first embodiment of the present invention.

Referring to FIG. 9, a substrate structure S may be prepared (S110). According to one embodiment, the substrate structure S may include: a base substrate 100; an insulating layer 200 disposed on the base substrate 100; and a silicon (Si) layer 300 disposed on the insulating layer 200.

Referring to FIG. 10, a central portion of the silicon layer 300 may be etched. In detail, the silicon layer 300 may be etched such that a level L₂ of the central portion of the silicon layer 300 is lower than a level L₁ of each of both ends of the silicon layer 300. The level L₂ of the central portion of the silicon layer may be defined as a height from a bottom surface to a top surface of the central portion of the silicon layer, and the level L₁ of each of the both ends of the silicon layer may be defined as a height from a bottom surface to a top surface of each of the both ends of the silicon layer. As the central portion of the silicon layer 300 is etched, a first empty space ES₁ may be formed in the central portion of the silicon layer 300 (S120).

Referring to FIG. 11, a first region 310 of the etched silicon layer 300 may be doped into a first conductivity type, and a second region 320 of the etched silicon layer 300, which is arranged side by side with the first region 310, may be doped into a second conductivity type. According to one embodiment, the first region 310 may be doped into a p-type, and the second region 320 may be doped into an n-type. The first region 310 may be doped into the first conductivity type with boron (B), and the second region 320 may be doped into the second conductivity type with phosphorus (P). Accordingly, a slab waveguide 300 in which a PN junction is formed by the first region 310 and the second region 320 may be formed (S130).

According to one embodiment, the first region 310 may include first-first to first-third slab regions 311, 312, and 313, and the first-first to first-third slab regions 311, 312, and 313 may be doped at mutually different concentrations. For example, the first-first slab region 311 may be doped at a concentration of 10²⁰ cm⁻³. Meanwhile, the first-second slab region 312 may be doped at a concentration of 10¹⁹ cm⁻³. Meanwhile, the first-third slab region 313 may be doped at a concentration of 10¹⁸ cm⁻³.

The second region 320 may include second-first to second-third slab regions 321, 322, and 323, and the second-first to second-third slab regions 321, 322, and 323 may be doped at mutually different concentrations. For example, the second-first slab region 321 may be doped at a concentration of 10²⁰ cm⁻³. Meanwhile, the second-second slab region 322 may be doped at a concentration of 10¹⁹ cm⁻³. Meanwhile, the second-third slab region 323 may be doped at a concentration of 10¹⁸ cm⁻³.

The first-first to first-third slab regions 311, 312, and 313 may be arranged side by side. The second-first to second-third slab regions 321, 322, and 323 may be arranged side by side. In this case, the first-third slab region 313 and the second-third slab region 323 may make contact with each other.

In addition, a thickness of the first-first slab region 311 may be thicker than a thickness of each of the first-second slab region 312 and the first-third slab region 313. A thickness of the second-first slab region 321 may be thicker than a thickness of each of the second-second slab region 322 and the second-third slab region 323.

Referring to FIGS. 12 and 13, a mask M may be deposited in the first empty space ES₁ formed in a central portion of the slab waveguide 300 (S140). Thereafter, a second empty space ES₂ may be formed between the slab waveguide 300 and the mask M by etching the mask M to expose a portion of the first-third slab region 313 and a portion of the second-third slab region 323 (S150).

Referring to FIG. 14, a rib waveguide 400 may be formed by sequentially stacking first to third rib waveguide layers 410, 420, and 430 in the second empty space ES₂ (S160). According to one embodiment, the forming of the rib waveguide 400 (S160) may include: forming a first rib waveguide layer 410 in the second empty space ES₂ by growing silicon (Si) from the slab waveguide 300 (S161); forming a second rib waveguide layer 420 on the first rib waveguide layer 410 by growing silicon-germanium (SiGe) from the first rib waveguide layer 410 (S162); and forming a third rib waveguide layer 430 on the second rib waveguide layer 420 by growing silicon (Si) from the second rib waveguide layer 420 (S163).

According to one embodiment, all of the first to third rib waveguide layers 410, 420, and 430 may be doped into the first conductivity type (p-type). In addition, a thickness of the first rib waveguide layer 410 may be thinner than a thickness of the third rib waveguide layer 430.

Referring to FIG. 15, a first electrode 610 may be formed on the first-first slab region 311, and a second electrode 620 may be formed on the second-first slab region 321 (S170). Thereafter, a protective layer 500 may be formed on the slab waveguide 300 such that one side of the protective layer 500 makes contact with the first electrode 610, an opposite side of the protective layer 500 makes contact with the second electrode 620, and the protective layer 500 covers the rib waveguide 400 (S170). Accordingly, the optical phase shifter may be manufactured.

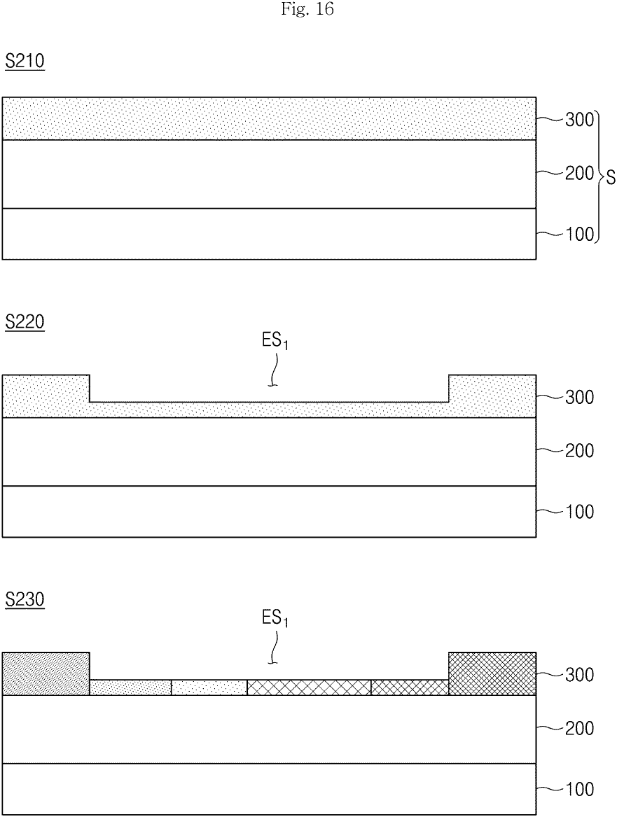

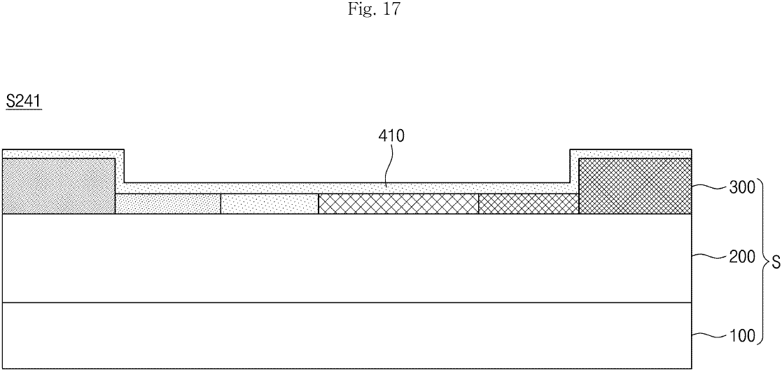

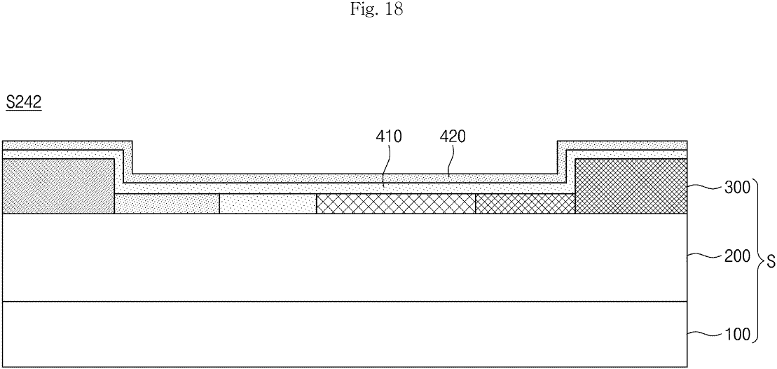

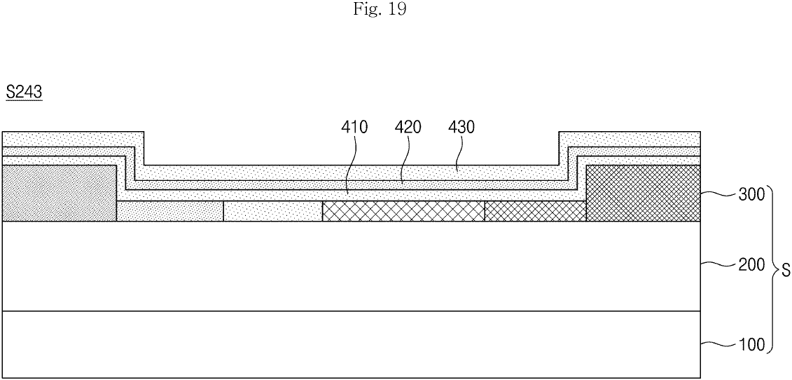

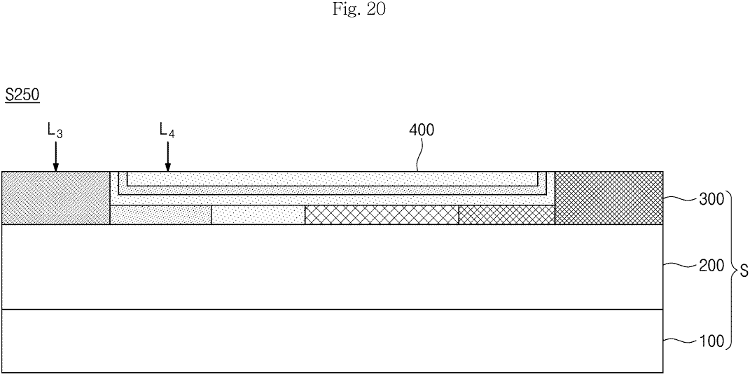

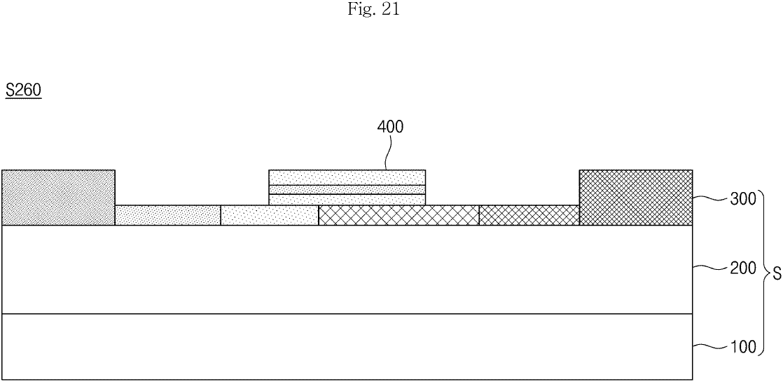

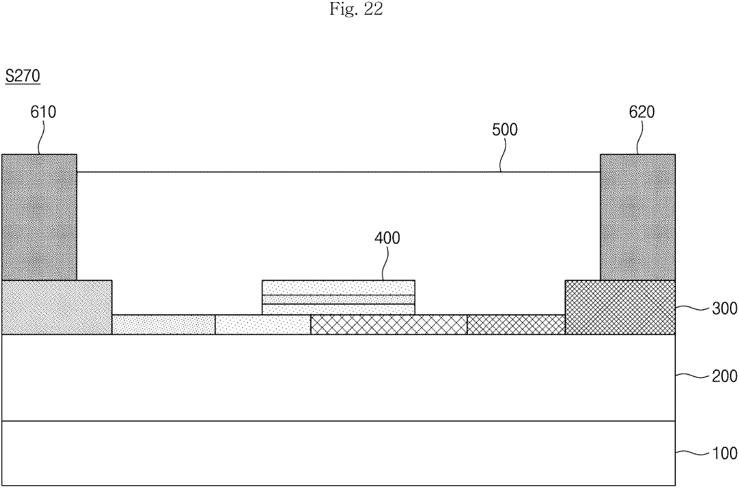

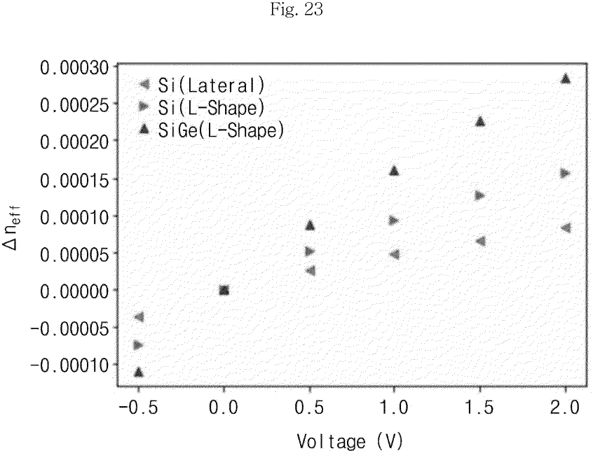

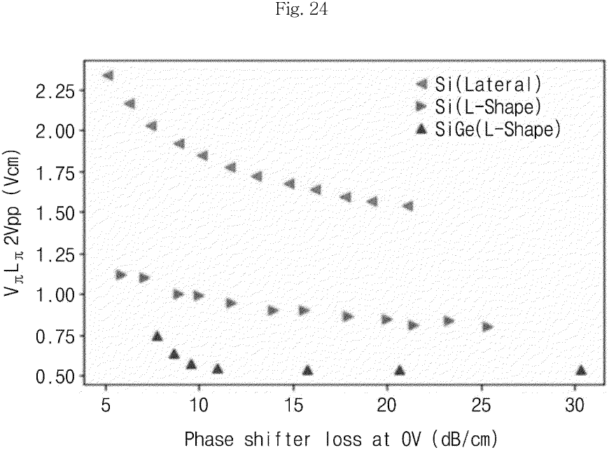

FIG. 16 is a view for describing steps S210, S220, and S230 of a method for manufacturing the optical phase shifter according to the second embodiment of the present invention, FIG. 17 is a view for describing a step S241 of the method for manufacturing the optical phase shifter according to the second embodiment of the present invention, FIG. 18 is a view for describing a step S242 of the method for manufacturing the optical phase shifter according to the second embodiment of the present invention, FIG. 19 is a view for describing a step S243 of the method for manufacturing the optical phase shifter according to the second embodiment of the present invention, FIG. 20 is a view for describing a step S250 of the method for manufacturing the optical phase shifter according to the second embodiment of the present invention, FIG. 21 is a view for describing a step S260 of the method for manufacturing the optical phase shifter according to the second embodiment of the present invention, FIG. 22 is a view for describing a step S270 of the method for manufacturing the optical phase shifter according to the second embodiment of the present invention, FIG. 23 is a graph for comparing effective refractive index change amounts of optical phase shifters according to Experimental Example and Comparative Examples of the present invention, and FIG. 24 is a graph for comparing modulation efficiencies of the optical phase shifters according to Experimental Example and Comparative Examples of the present invention.

Referring to FIG. 16, a substrate structure S may be prepared (S210). According to one embodiment, the substrate structure S may include: a base substrate 100; an insulating layer 200 disposed on the base substrate 100; and a silicon (Si) layer 300 disposed on the insulating layer 200.

A central portion of the silicon layer 300 may be etched. In detail, the silicon layer 300 may be etched such that a level L₂ of the central portion of the silicon layer 300 is lower than a level L₁ of each of both ends of the silicon layer 300. The level L₂ of the central portion of the silicon layer may be defined as a height from a bottom surface to a top surface of the central portion of the silicon layer, and the level L₁ of each of the both ends of the silicon layer may be defined as a height from a bottom surface to a top surface of each of the both ends of the silicon layer. As the central portion of the silicon layer 300 is etched, a first empty space ES₁ may be formed in the central portion of the silicon layer 300 (S220).

A first region 310 of the etched silicon layer 300 may be doped into a first conductivity type, and a second region 320 of the etched silicon layer 300, which is arranged side by side with the first region 310, may be doped into a second conductivity type. According to one embodiment, the first region 310 may be doped into a p-type, and the second region 320 may be doped into an n-type. The first region 310 may be doped into the first conductivity type with boron (B), and the second region 320 may be doped into the second conductivity type with phosphorus (P). Accordingly, a slab waveguide 300 in which a PN junction is formed by the first region 310 and the second region 320 may be formed (S230). A specific manufacturing process of the step S230 may be the same as the specific process of the step S130 described with reference to FIG. 11.

Referring to FIGS. 17 to 19, the rib waveguide 400 may be filled in the first empty space ES₁ (S240). In detail, as shown in FIG. 17, a first rib waveguide layer 410 including silicon (Si) may be formed on the slab waveguide 300 along a surface profile of the slab waveguide 300. Thereafter, as shown in FIG. 18, a second rib waveguide layer 420 including silicon-germanium (SiGe) may be formed on the first rib waveguide layer 410 along a surface profile of the first rib waveguide layer 410. Thereafter, as shown in FIG. 19, a third rib waveguide layer 430 including silicon (Si) may be formed on the second rib waveguide layer 420 along a surface profile of the second rib waveguide layer 420.

Accordingly, the rib waveguide 400 obtained by sequentially stacking the first to third rib waveguide layers 410, 420, and 430 may be formed in the first empty space ES₁ and on both ends of the slab waveguide 300. The both ends of the slab waveguide 300 may be defined as the first-first slab region 311 and the second-first slab region 321. In other words, the rib waveguide 400 in which the first to third rib waveguide layers 410, 420, and 430 are sequentially stacked may be formed on the first-first slab region 311 and the second-first slab region 321 as well as in the first empty space ES₁.

Referring to FIG. 20, the rib waveguide 400 formed on the both ends of the slab waveguide 300 may be removed while allowing the rib waveguide 400 filling the first empty space ES₁ to remain. Accordingly, planarization may be performed such that a level L₃ of a top surface of each of the both ends of the slab waveguide 300 and a level L₄ of a top surface of the rib waveguide 400 filling the first empty space ES₁ may be the same (S250) . According to one embodiment, the planarization may be performed through a chemical mechanical polishing (CMP) process.

Referring to FIG. 21, the rib waveguide 400 filling the first empty space ES₁ may be etched (S260). In detail, the etching may be performed to expose a portion of the first-third slab region 313 and an entire area of the first-second slab region 312. In addition, the etching may be performed to expose a portion of the second-third slab region 323 and an entire area of the second-second slab region 322.

Referring to FIG. 22, a first electrode 610 may be formed on the first-first slab region 311, and a second electrode 620 may be formed on the second-first slab region 321 (S270). Thereafter, a protective layer 500 may be formed on the slab waveguide 300 such that one side of the protective layer 500 makes contact with the first electrode 610, an opposite side of the protective layer 500 makes contact with the second electrode 620, and the protective layer 500 covers the rib waveguide 400 (S270). Accordingly, the optical phase shifter may be manufactured.

The methods for manufacturing the optical phase shifters according to the embodiments of the present invention have been described above. Hereinafter, a specific experimental example and a characteristic evaluation result of an optical phase shifter according to an embodiment of the present invention will be described.

### Preparation of Optical Phase Shifter According to Experimental Example

An optical phase shifter having a structure as described with reference to FIG. 3 is prepared. The optical phase shifter according to Experimental Example is defined as SiGe(L-shape).

### Preparation of Optical Phase Shifter According to Comparative Example 1

An optical phase shifter having a structure described with reference to FIG. 3 and including a rib waveguide formed of only silicon (Si) without silicon-germanium (SiGe) is prepared. The optical phase shifter according to Comparative Example 1 is defined as Si(L-shape).

### Preparation of Optical Phase Shifter According to Comparative Example 2

An optical phase shifter that is the same as the optical phase shifter according to Comparative Example 1 described above while thicknesses of first-first to first-third slab regions included in a slab waveguide are equal to each other, and thicknesses of second-first to second-third slab regions are equal to each other is prepared. The optical phase shifter according to Comparative Example 2 is defined as Si(Lateral).

FIG. 23 is a graph for comparing effective refractive index change amounts of optical phase shifters according to Experimental Example and Comparative Examples of the present invention.

Referring to FIG. 23, after the optical phase shifter according to Experimental Example (SiGe(L-shape)), the optical phase shifter according to Comparative Example 1 (Si(L-shape)), and the optical phase shifter according to Comparative Example 2 (Si(Lateral)) are prepared, an effective refractive index change amount Δn_{eff} according to a voltage (V) was measured for each of the optical phase shifters.

As shown in FIG. 23, it was found that the effective refractive index change amount of each of the optical phase shifters according to Experimental Example and Comparative Example 1 having an L-shape structure is greater than the effective refractive index change amount of the optical phase shifter according to Comparative Example 2 having a lateral structure.

In addition, it was found that the optical phase shifter according to Experimental Example in which the rib waveguide includes silicon-germanium (SiGe) has a greater effective refractive index change amount than the optical phase shifter according to Comparative Example 1 in which the rib waveguide includes only silicon (Si).

FIG. 24 is a graph for comparing modulation efficiencies of the optical phase shifters according to Experimental Example and Comparative Examples of the present invention.

Referring to FIG. 24, after the optical phase shifter according to Experimental Example (SiGe(L-shape)), the optical phase shifter according to Comparative Example 1 (Si(L-shape)), and the optical phase shifter according to Comparative Example 2 (Si(Lateral)) are prepared, V_{π} and L_{π} according to a phase shifter loss at 0 V (dB/cm) were measured for each of the optical phase shifters. In this case, V_{π} and L_{π} represent multiplication of a driving voltage required to change a phase by n and a length of the phase shifter. In addition, V_{π} and L_{π} are values representing a modulation efficiency, and a modulation efficiency of a modulator may be improved as V_{π} and L_{π} become smaller. In addition, V_{π} and L_{π} may be in inverse proportion to the effective refractive index change amount.

As shown in FIG. 24, it was found that V_{π} and L_{π} are smallest in the optical phase shifter according to Experimental Example (SiGe(L-shape)), V_{π} and L_{π} have intermediate values in the optical phase shifter according to Comparative Example 1 (Si(L-shape)), and V_{π} and L_{π} are the largest in the optical phase shifter according to Comparative Example 2 (Si(Lateral)).

As a result, it was found that the optical phase shifter according to Experimental Example (SiGe(L-shape)) has a better optical modulation efficiency than each of the optical phase shifter according to Comparative Example 1 (Si(L-shape)) and the optical phase shifter according to Comparative Example 2 (Si (Lateral)).

Although the exemplary embodiments of the present invention have been described in detail above, the scope of the present invention is not limited to a specific embodiment, and should be interpreted by the appended claims. In addition, it should be understood by those of ordinary skill in the art that various changes and modifications can be made without departing from the scope of the present invention.

What is claimed is:

1. An optical phase shifter comprising:
a slab waveguide in which a first slab region doped into a first conductivity type and a second slab region doped into a second conductivity type are arranged side by side to form a PN junction; and
a rib waveguide disposed on the slab waveguide such that one side of the rib waveguide makes contact with the first slab region, and an opposite side of the rib waveguide makes contact with the second slab region,
wherein the rib waveguide includes first to third rib waveguide layers that are sequentially stacked,
the first and third rib waveguide layers include silicon (Si), and
the second rib waveguide layer includes silicon-germanium (SiGe).

2. The optical phase shifter of claim 1, wherein, when a reverse voltage is applied to the optical phase shifter, concentrations of electrons and holes in the second rib waveguide layer are changed to change a refractive index of the second rib waveguide layer, and
a phase of a light passing through the second rib waveguide layer is controlled by the change of the refractive index.

3. The optical phase shifter of claim 1, wherein a thickness of the first rib waveguide layer that is adjacent to the slab waveguide is thinner than a thickness of the third rib waveguide layer.

4. The optical phase shifter of claim 1, wherein a depletion layer is formed between the first slab region and the second slab region and between the second slab region and the first rib waveguide layer, and,
when a reverse voltage is applied to the optical phase shifter, an area of the depletion layer is increased.

5. The optical phase shifter of claim 1, wherein the first to third rib waveguide layers are doped into the first conductivity type.

6. The optical phase shifter of claim 1, wherein the first slab region includes a first-first slab region having a first doping concentration, a first-second slab region having a second doping concentration that is lower than the first doping concentration, and a first-third slab region having a third doping concentration that is lower than the second doping concentration,
the first-first to first-third slab regions are arranged side by side with each other,
the second slab region includes a second-first slab region having a first doping concentration, a second-second slab region having a second doping concentration that is lower than the first doping concentration, and a second-third slab region having a third doping concentration that is lower than the second doping concentration, and
the second-first to second-third slab regions are arranged side by side with each other.

7. The optical phase shifter of claim 6, wherein the slab waveguide is disposed such that the first-third slab region and the second-third slab region make contact with each other.

8. The optical phase shifter of claim 7, wherein a thickness of the first-first slab region is thicker than a thickness of each of the first-second slab region and the first-third slab region, and
a thickness of the second-first slab region is thicker than a thickness of each of the second-second slab region and the second-third slab region.

9. The optical phase shifter of claim 1, wherein, when an area in which the second slab region and the first rib waveguide layer overlap is relatively widened, an optical modulation efficiency is improved while an optical modulation speed is reduced, and,
when an area in which the second slab region and the first rib waveguide layer overlap is relatively narrowed, the optical modulation efficiency is reduced while the optical modulation speed is improved.

10. The optical phase shifter of claim 1, wherein the rib waveguide further includes:
a fourth rib waveguide layer including silicon-germanium (SiGe) and disposed on the third rib waveguide layer; and
a fifth rib waveguide layer including silicon (Si) and disposed on the fourth rib waveguide layer.

11. A method for manufacturing an optical phase shifter, the method comprising:
preparing a substrate structure in which a base substrate, an insulating layer, and a silicon (Si) layer are sequentially stacked;
forming a first empty space in a central portion of the silicon layer by etching the central portion of the silicon layer such that a level of the central portion of the silicon layer is lower than a level of each of both ends of the silicon layer;
forming a slab waveguide in which a PN junction is formed by a first region and a second region by doping a first region of the etched silicon layer into a first conductivity type and doping a second region of the etched silicon layer, which is arranged side by side with the first region of the etched silicon layer, into a second conductivity type;
depositing a mask in the first empty space formed in a central portion of the slab waveguide;
forming a second empty space between the slab waveguide and the mask by etching the mask to expose a portion of the first region and a portion of the second region;
forming a rib waveguide in which first to third rib waveguide layers are sequentially stacked in the second empty space; and
forming electrodes on the first region and the second region of the slab waveguide, respectively,
wherein the first and third rib waveguide layers include silicon (Si), and
the second rib waveguide layer includes silicon-germanium (SiGe).

12. The method of claim 11, wherein the forming of the rib waveguide in the second empty space includes:
forming a first rib waveguide layer in the second empty space by growing silicon (Si) from the slab waveguide;
forming a second rib waveguide layer on the first rib waveguide layer by growing silicon-germanium (Si—Ge) from the first rib waveguide layer; and
forming a third rib waveguide layer on the second rib waveguide layer by growing silicon (Si) from the second rib waveguide layer.

13. A method for manufacturing an optical phase shifter, the method comprising:
preparing a substrate structure in which a base substrate, an insulating layer, and a silicon (Si) layer are sequentially stacked;
forming an empty space in a central portion of the silicon layer by etching the central portion of the silicon layer such that a level of the central portion of the silicon layer is lower than a level of each of both ends of the silicon layer;
forming a slab waveguide in which a PN junction is formed by a first region and a second region by doping a first region of the etched silicon layer into a first conductivity type and doping a second region of the etched silicon layer, which is arranged side by side with the first region of the etched silicon layer, into a second conductivity type;
filling the empty space formed in a central portion of the slab waveguide with a rib waveguide in which first to third rib waveguide layers are stacked by sequentially forming the first to third rib waveguide layers along a surface profile of the slab waveguide;
performing planarization such that a top surface of each of both ends of the slab waveguide and a top surface of the rib waveguide filling the empty space have a same level by removing the rib waveguide formed on the both ends of the slab waveguide while allowing the rib waveguide filling the empty space to remain;
etching the rib waveguide filling the empty space to expose a portion of the first region of the slab waveguide and a portion of the second region of the slab waveguide; and
forming electrodes on the first region and the second region of the slab waveguide, respectively.

14. The method of claim 13, wherein the first and third rib waveguide layers include silicon (Si), and
the second rib waveguide layer includes silicon-germanium (SiGe).
